(19) United States
(12) Patent Application Publication
(10) Pub. No.: US 2023/0081217 A1
(43) Pub. Date: Mar. 16, 2023

(54) STRUCTURE FOR INJECTING COOLING OIL

(71) Applicants: Hyundai Motor Company, Seoul (KR); Kia Corporation, Seoul (KR)

(72) Inventor: Jae Hyeon LEE, Hwaseong-Si (KR)

(73) Assignees: Hyundai Motor Company, Seoul (KR); Kia Corporation, Seoul (KR)

(21) Appl. No.: 17/472,248

(22) Filed: Sep. 10, 2021

(51) Int. Cl. H02K 9/193; H02K 3/28

(52) U.S. Cl. CPC H02K 9/193; H02K 3/28; H02K 2209/00

(57) ABSTRACT

A structure for injecting cooling oil includes a motor having a stator core and coils wound on the stator core and protruding from the stator core and extending obliquely in an axial direction of the stator core; a first cooling pipe mounted at a first side of the motor and having a first injection hole to inject oil onto the coils therethrough; and a second cooling pipe mounted at a second side of the motor and having a second injection hole injecting oil into the coils, wherein the first injection hole injects oil onto portions of the coils extending obliquely outwards from the stator core in a direction moving away from the first injection hole and the second injection hole injects oil onto portions of the coils extending obliquely toward the stator core in a direction moving away from the second injection hole.

### CROSS-REFERENCE TO RELATED APPLICATION

The present application claims priority to Korean Patent Application No. 10-2020-0188618 filed on Dec. 31, 2020, the entire contents of which is incorporated herein for all purposes by this reference.

### BACKGROUND OF THE INVENTION

### Field of the Invention

The present invention relates to a structure for injecting cooling oil. More particularly, it relates to a structure for injecting cooling oil which enables the cooling oil injected into a motor through cooling pipes to more effectively permeate into coils of the motor.

### Description of Related Art

Eco-friendly vehicles refer to hybrid electric vehicles (HEVs), plug-in hybrid electric vehicles (PHEVs), battery electric vehicles (BEVs), fuel cell electric vehicles (FCEVs) and the like, to which high-capacity high-voltage batteries that are electrically chargeable are applied.

In these eco-friendly vehicles, a motor driven using power of the high-voltage battery performs a key functional role in driving of the vehicle. The motor has efficiency of about 90% due to loss caused by heat, wind, noise, etc., and heat, accounting for about 25% of the loss, causes the temperature of the motor to exceed an allowable temperature. The allowable temperature is the upper limit of a temperature range in which the motor is stably operable. When the temperature of the motor exceeds the allowable temperature, damage to coils wound on a stator of the motor or demagnetization of permanent magnets included in a rotor of the motor may occur due to overheating. Therefore, a cooling system is provided in the motor to operate the motor within the allowable temperature range. The motor also essentially requires miniaturization, high cooling performance to output high power, and high efficiency.

Cooling methods of motors may be classified into a water cooling method, an air cooling method and an oil cooling method according to the type of cooling fluid which is used. Also, the cooling methods of motors may be classified into a direct cooling method and an indirect cooling method according to the contact method which is used. Recently, as cooling performance of motors is growing in importance to satisfy the high performance requirements of motors, a direct oil cooling method which shows improved cooling efficiency is mainly used at present.

The direct cooling methods are classified into a rotor shaft scattering method using rotation of a motor, a pumping method using an electric oil pump, and a submerging method using submerging in oil according to the injection method. In recent times, to satisfy higher cooling performance, combinations of cooling of a stator using an electric oil pump, cooling of a rotor through the shaft scattering method, and submersion in oil are increasingly used.

Recently, to realize high efficiency of a cooling system, various research on motor cooling systems is being vigorously conducted. The research may include optimized design of the injection angle, the position, the size and the number of cooling pipes configured to inject oil at a designated pressure. Moreover, included are designs of the shapes of a motor and a housing for optimizing cooling, improvements of an inject structure for cooling, developments of structures for assisting cooling.

The information disclosed in this Background of the Invention section is only for enhancement of understanding of the general background of the invention and may not be taken as an acknowledgement or any form of suggestion that this information forms the prior art already known to a person skilled in the art.

### BRIEF SUMMARY

Various aspects of the present invention are directed to providing a structure for injecting cooling oil for motors, which may improve cooling performance and cooling efficiency.

Various aspects of the present invention are directed to providing a structure for injecting cooling oil, the structure including a motor including a stator core and coils wound on the stator core, wherein the coils protrude from the stator core and extend obliquely in an axial direction of the stator core; a first cooling pipe mounted at a first side of the motor at a distance apart from the coils and including a first injection hole to inject oil onto the coils therethrough; and a second cooling pipe mounted at a second side of the motor at a space apart from the coils and including a second injection hole to inject oil onto the coils therethrough, wherein the first injection hole is configured to inject oil onto portions of the coils extending obliquely outwards from the stator core in a direction moving away from the first injection hole; the second injection hole is configured to inject oil onto portions of the coils extending obliquely toward the stator core in a direction moving away from the second injection hole; and the second injection hole has a diameter greater than a diameter of the first injection hole.

In another aspect, various aspects of the present invention are directed to providing a structure for injecting cooling oil, the structure including a motor including a stator core and coils wound on the stator core; a first cooling pipe mounted at a first side of the motor to be spaced from the coils with a predetermined distance and including a first front injection hole injecting oil onto first front portions of the coils and a first rear injection hole injecting oil onto first rear portions of the coils; and a second cooling pipe mounted at a second side of the motor to be spaced from the coils with a predetermined distance and including a second front injection hole injecting oil onto second front portions of the coils and a second rear injection hole injecting oil onto second rear portions of the coils, wherein the first front portion is a portion of each of the coils protruding obliquely outwards from the stator core and then extending in a direction moving away from the first cooling pipe, and the second front portion is a portion of each of the coils protruding obliquely outwards from the stator core and then extending in a direction approaching the second cooling pipe; the first rear portion is a portion of each of the coils protruding obliquely outwards from the stator core and then extending in a direction approaching the first cooling pipe, and the second rear portion is a portion of each of the coils protruding obliquely outwards from the stator core and then extending in a direction moving away from the second cooling pipe; the second front injection hole has a diameter greater than a diameter of the first front injection hole; and the second rear injection hole has a diameter smaller than a diameter of the first rear injection hole.

Other aspects and exemplary embodiments of the present invention are discussed infra.

The above and other features of the present invention are discussed infra.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a block diagram of a motor cooling system for vehicles;

FIG. 2 is a top view of a hairpin winding motor according to various exemplary embodiments of the present invention;

FIG. 3 is a front view of the hairpin winding motor according to various exemplary embodiments of the present invention;

FIG. 4 is a perspective view exemplarily illustrating a front left portion of the hairpin winding motor shown in FIG. 2;

FIG. 5 is a perspective view exemplarily illustrating a front right portion of the hairpin winding motor shown in FIG. 2;

FIG. 6A is a perspective view exemplarily illustrating the front left portion of the hairpin winding motor shown in FIG. 2; and

FIG. 6B is a perspective view exemplarily illustrating a modified example of the front right portion of the hairpin winding motor shown in FIG. 2.

It may be understood that the appended drawings are not necessarily to scale, presenting a somewhat simplified representation of various exemplary features illustrative of the basic principles of the present invention. The specific design features of the present invention as included herein, including, for example, specific dimensions, orientations, locations, and shapes, will be determined in part by the particular intended application and use environment.

In the figures, reference numbers refer to the same or equivalent portions of the present invention throughout the several figures of the drawing.

### DETAILED DESCRIPTION

Hereinafter, exemplary embodiments of the present invention will be described in detail with reference to the accompanying drawings. Specific structures or functions described in the exemplary embodiments of the present invention are merely for illustrative purposes. Embodiments according to the concept of the present invention may be implemented in various forms, and it may be understood that they may not be construed as being limited to the exemplary embodiments described in the exemplary embodiment, but include all of modifications, equivalents, or substitutes included in the spirit and scope of the present invention.

It will be understood that, although the terms “first,” “second,” etc. may be used herein to describe various elements, these elements may not be limited by these terms. These terms are only used to distinguish one element from another element. For instance, a first element discussed below could be termed a second element without departing from the teachings of the present invention. Similarly, the second element could also be termed the first element.

It will be understood that when an element is referred to as being “coupled” or “connected” to another element, it may be directly coupled or connected to the other element or intervening elements may be present therebetween. In contrast, it should be understood that when an element is referred to as being “directly coupled” or “directly connected” to another element, there are no intervening elements present. Other expressions that explain the relationship between elements, such as “between,” “directly between,” “adjacent to,” or “directly adjacent to,” should be construed in the same way.

Like reference numerals denote like components throughout the specification. In the meantime, the terminology used herein is for describing various exemplary embodiments only and is not intended to be limiting. As used herein, the singular forms “a,” “an,” and “the” are intended to include the plural forms as well, unless the context clearly indicates otherwise. It will be further understood that the terms “comprise,” “include,” “have,” etc., when used in the exemplary embodiment, specify the presence of stated components, steps, operations, or elements, but do not preclude the presence or addition of one or more other components, steps, operations, and/or elements thereof.

Hereinafter, reference will be made in detail to various embodiments of the present invention, examples of which are illustrated in the accompanying drawings and described below.

FIG. 1 is a block diagram of a motor cooling system for eco-friendly vehicles. The motor cooling system is operated in cooperation with a cooling water system 500 of a vehicle. In the cooling water system 500 of the vehicle, cooling water supplied from a vehicle cooling system 510 including an electric water pump and a radiator cools an inverter 520, and is then circulated to the vehicle cooling system 510 via a heat exchanger 620.

In a cooling oil system 600, when an electric oil pump 610 pumps oil by applying pressure to the oil, the oil starts to be circulated. The oil in the heat exchanger 620 exchanges heat with the cooling water having a relatively low temperature of the cooling water system 500 so that the temperature of the oil is lowered. Then the oil having the lowered temperature is injected into a motor 630 through cooling pipes 640, and thus, lowers the temperature of the motor 630.

After cooling the motor 630, the oil flows to a reducer 650 and cools the reducer 650 through gear churning. After cooling the motor 630 and the reducer 650, the oil is filtered by an oil filter 660 to remove impurities from the oil, and is then returned to the electric oil pump 610, being recirculated. The motor cooling system has temperature sensors 670 configured to measure the temperature of the oil having passed through the oil filter 660, the temperature of the oil having passed through the heat exchanger 620, and the temperature of the motor 630 to detect the respective temperatures of the oil.

According to various exemplary embodiments of the present invention, the motor 630 may be more effectively cooled through a structure for injecting cooling oil configured to inject an optimum amount of oil from the cooling pipes 640 in consideration of coils of the motor 630.

The structure for injecting cooling oil according to various exemplary embodiments of the present invention may minimize the amount of oil which is injected into the coils of the motor 630 through the cooling pipes 640 but is wasted without being used for cooling due to the shape of the coils. Hence, the structure according to various exemplary embodiments of the present invention may maximize the effective amount of oil used for cooling the motor 630.

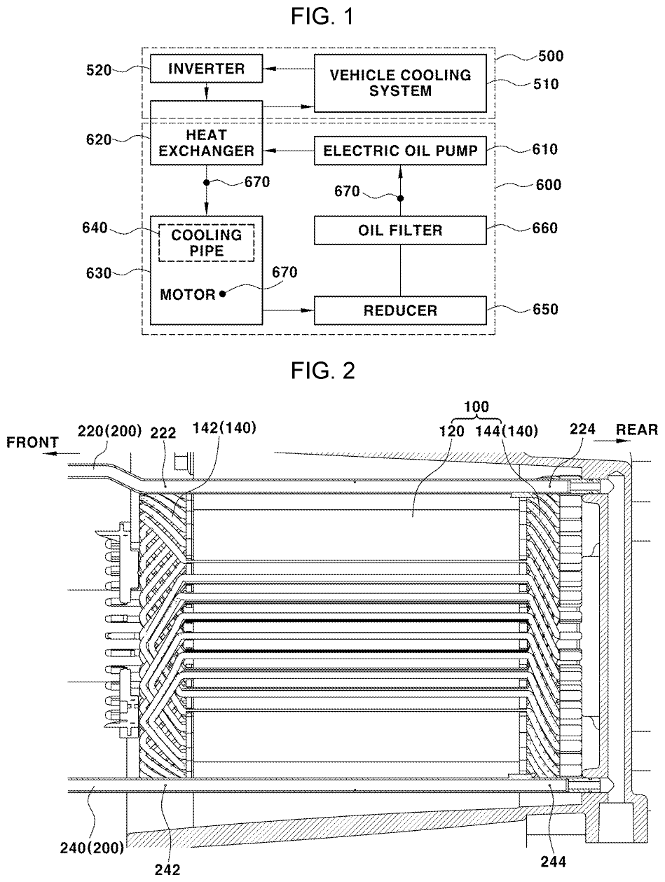

Hereinafter, the structure for injecting cooling oil for motors according to various exemplary embodiments of the present invention will be described in more detail with reference to FIGS. 2 to 6B.

The motor 630 includes a stator 100 and a rotor. The stator 100 includes a stator core 120 and coils 140. The coils 140 are wound on the stator core 120, and the stator 100 is coupled to the inside of a motor housing. Permanent magnets are mounted along the circumference of the rotor, and the rotor is disposed inside the stator 100. That is, the motor 630 may be a permanent magnet synchronous motor (PMSM).

According to various exemplary embodiments of the present invention, the motor 630 may be a hairpin winding motor. In general, motors may be classified into various types according to the winding method of the coil. Among these types, a hairpin winding motor is configured such that coil frames are arranged at both end portions of the stator core 120 at an oblique angle as depicted in FIG. 2. The respective coils 140 protrude outwards from respective end portions of the stator core 120. According to various exemplary embodiments of the present invention, the coils 140 protruding from the front end portion of the stator core 120 and the coils 140 protruding from the rear end portion of the stator core 120 include regions which are inclined obliquely in the same direction thereof, when viewed from the front portion or the rear portion of the motor 630. For example, viewing the front portion of the motor 630 from the rear portion of the motor 630, if the coils 140 at the front end portion of the stator core 120 protrude from the stator core 120 obliquely in the clockwise direction based on the axial direction of the stator core 120, the coils 140 at the rear end portion of the stator core 120 enter the stator core 120 obliquely in the clockwise direction thereof.

According to various exemplary embodiments of the present invention, the coils 140 of the motor 630 protrude from the stator core 120 obliquely with respect to the axial direction of the stator core 120. The coils 140, which protrude from the stator core 120 obliquely, are bent at least once in the radial direction and the circumferential direction of the stator core 120 and in at least one of the radial direction and the circumferential direction thereof, respectively. Thereafter, the bent coils 140 enter the stator core 120 obliquely with respect to the axial direction of the stator core 120.

Oil is supplied to the coils 140 through cooling pipes 200. The cooling pipes 200 supply oil pumped by the electric oil pump 610 to the motor 630. In more detail, a plurality of injection holes is formed through the cooling pipes 200. The oil is injected into the coils 140 through the injection holes.

Here, due to the oblique shape of the coils 140, some oil supplied through the cooling pipes 200 hits the coils 140 and bounces off of the coils 140 to the outside without penetrating the coils 140, which may be called an oil waste phenomenon.

Because oil waste occurs when injected oil hits the coils 140 and thus bounces off of the coils 140 to the outside of the coils 140 or to the motor housing, the amount of oil actually used to cool the motor 630 is reduced compared to the amount of oil which is supplied. Consequently, cooling efficiency is reduced. The present problem occurs not only when the amount of oil is high (for example, 10 liters per minute (LPM)) but also when the amount of oil is low (for example, 4 to 6 LPM). Thus, solutions to the oil waste phenomenon are required.

Therefore, in various exemplary embodiments of the present invention, the sizes of the injection holes in the cooling pipes 200, which are disposed to face each other, are adjusted in consideration of the shape of the coils 140. By decreasing the diameter of the holes in the cooling pipe 200 through which oil which is injected is expected to bounce off of the coils 140 to the outside and increasing the diameter of the holes in the cooling pipe 200 facing the same in consideration of the shape of the coils 140, the amount of oil permeating into the coils 140 may be increased.

The cooling pipes 200 may have any of various shapes, such as a rectilinear shape, a circular shape or a combined shape. Also, no cooling pipes 200 or a plurality of cooling pipes 200, up to three cooling pipes 200, may be provided. In general, two cooling pipes 200 are used as oil may be uniformly supplied to the left and right portions of the motor 630.

In various exemplary embodiments of the present invention, a pair of cooling pipes 200, which are disposed at the left and right portions of the motor 630, is provided by way of example. The cooling pipes 200 may be disposed above the motor 630.

According to various exemplary embodiments of the present invention, a first cooling pipe 220 and a second cooling pipe 240 are disposed to face each other with respect to the motor 630.

The first cooling pipe 220 includes a plurality of injection holes. The first cooling pipe 220 may include a first front injection hole 222 provided at the front portion of the motor 630 and a first rear injection hole 224 provided at the rear portion of the motor 630.

The second cooling pipe 240 includes a plurality of injection holes. The second cooling pipe 240 may include a second front injection hole 242 provided at the front portion of the motor 630 and a second rear injection hole 244 provided at the rear portion of the motor 630.

According to various exemplary embodiments of the present invention, the first front injection hole 222 and the second front injection hole 242 are symmetrical with each other about the motor 630. That is, the injection angle of the first front injection hole 222 and the injection angle of the second front injection hole 242 are substantially the same.

Furthermore, the first rear injection hole 224 and the second rear injection hole 244 are symmetrical with each other about the motor 630. That is, the injection angle of the first rear injection hole 224 and the injection angle of the second rear injection hole 244 are substantially the same.

However, the first cooling pipe 220 and the second cooling pipe 240 may not be completely the same as each other. Also, the first front injection hole 222 and the second front injection hole 242 or the first rear injection hole 224 and the second rear injection hole 244 may not be completely symmetrical with each other. Accordingly, if angular conditions which will be described below are satisfied, the sizes of the corresponding injection holes may be varied in various exemplary embodiments of the present invention.

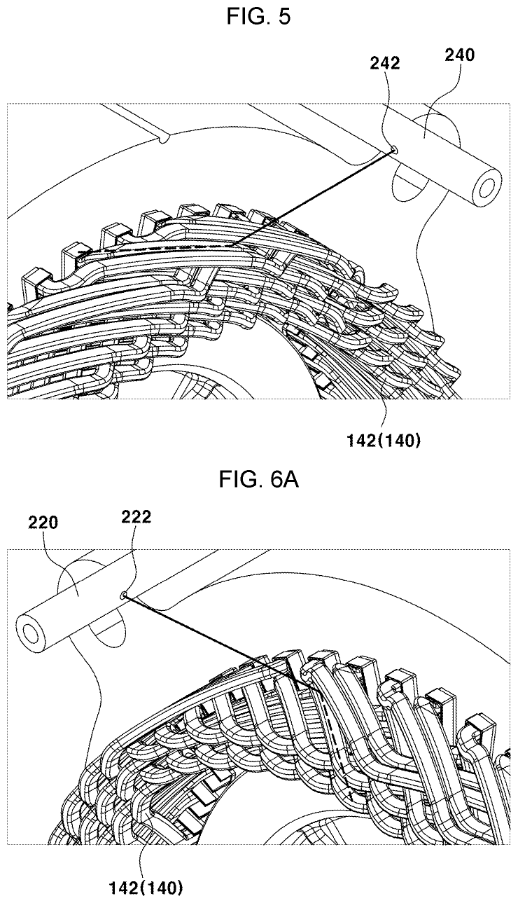

Referring to FIG. 4 and FIG. 5, after the oil injected through the first front injection hole 222 in the region of front-side coils 142 comes into contact with the front-side coils 142, the oil moves to the outside of the front-side coils 142 or in a direction moving away from the stator core 120. Alternatively, when viewed from the first front injection hole 222, the oil injected through the first front injection hole 222 is sprayed onto the portions of the front-side coils 142 which protrude outwards from the stator core 120 obliquely and then extend in a direction moving away from the first cooling pipe 220. Therefore, the oil bounces off in the clockwise direction obliquely to a line from the first front injection hole 222 to the front-side coil 142 with which the oil comes into contact (indicated by the dotted line of FIG. 4).

On the other hand, after the oil injected through the second front injection hole 242 in the region of the front-side coils 142 comes into contact with the front-side coils 142, the oil moves to the inside of the front-side coils 142 or in a direction approaching the stator core 120. Alternatively, as viewed from the second front injection hole 242, the oil injected through the second front injection hole 242 moves obliquely toward the stator core 120 and is sprayed onto the portions of the front-side coils 142 which extends in a direction moving away from the second cooling pipe 240. That is to say, the oil moves toward the coil 142 in the clockwise direction obliquely to a line from the second front injection hole 242 to the front-side coil 142, with which the oil comes into contact (indicated by the dotted line of FIG. 5).

Therefore, in the instant case, it may be predicted that a great loss of oil supplied from the first front injection hole 222 of the first cooling pipe 220 would be incurred. In the instant specification, the coils 140 which protrude from the front end portion of the stator core 120 will be referred to as the front-side coils 142, and the coils 140 which protrude from the rear end portion of the stator core 120 will be referred to as rear-side coils 144.

According to various exemplary embodiments of the present invention, the first front injection hole 222 has a smaller diameter than the diameter of the second front injection hole 242. Because the amount of oil injected through the second front injection hole 242 is increased, the second front injection hole 242 may provide higher cooling performance and higher cooling efficiency at the same flow rate (LPM).

Equation 1 below may be satisfied under the situation of the front-side coils 142.

d_{f2}=k·d_{f1} [Equation 1]

Here, d_{f2} is the diameter of the second front injection hole 242, and d_{f1} is the diameter of the first front injection hole 222. k, which is a coefficient of size change, may vary depending on environmental conditions and may preferably be 1 to 1.5, preferably be 1.2. The environmental conditions may include whether or not processing dimensions are changeable and the cooling environment.

As described above, as viewed from the rear portion of the stator core 120, when the front-side coils 142 extend in the direction moving away from the stator core 120 at an angle in the counterclockwise direction based on the axial direction of the stator core 120, the rear-side coils 142 extend toward the stator core 120 at an angle in the counterclockwise direction based on the axial direction of the stator core 120. Therefore, the rear-side coils 144 are in the opposite situation to the front-side coils 142. The oil injected through the second rear injection hole 244 of the second cooling pipe 240 bounces off of the rear-side coils 144 to the outside, whereas the oil injected through the first rear injection hole 224 of the first cooling pipe 220 enters the rear-side coils 144. Therefore, in the instant case, the first rear injection hole 224 has a greater diameter than the diameter of the second rear injection hole 244, as set forth in Equation 2 below.

dᵣ₁=k·dᵣ₂ [Equation 2]

Here, dᵣ₁ is the diameter of the first rear injection hole 224, and dᵣ₂ is the diameter of the second rear injection hole 244.

Furthermore, despite changes in the sizes of the first front injection hole 222, the second front injection hole 242, the first rear injection hole 224 and the second rear injection hole 244, the amounts and the injection pressures of oil injected through the respective cooling pipes 200 may remain the same. That is, as set forth in Equation 3 below, the diameter of the first rear injection hole 224 of the first cooling pipe 220 is increased as much as the diameter of the first front injection hole 222 is decreased. Also, the diameter of the second rear injection hole 244 of the second cooling pipe 240 is decreased as much as the diameter of the second front injection hole 242 is increased. Accordingly, the amounts and the injection pressures of oil injected through the first and second cooling pipes 220 and 240 may remain the same.

d_{f1}+dᵣ₁≅d_{f2}+dᵣ₂ [Equation 3]

Therefore, the structure for injecting cooling oil according to various exemplary embodiments of the present invention may provide improved cooling performance and efficiency at the same flow rate (LPM), compared to the conventional structure for injecting cooling oil.

As described above, the cooling pipes 200 may not be completely symmetrical with each other about the motor 630. The positions of the injection holes formed in the respective cooling pipes 200 may not be completely symmetrical with each other. The range of the upper portions of the coils 140 may not be clear. Therefore, according to various exemplary embodiments of the present invention, if predetermined angular conditions are satisfied, it is determined that the injection holes located to face each other cool the same position of the motor 630. Upon determining that the injection holes located to face each other cool the same position of the motor 630, the sizes of the injection holes may vary.

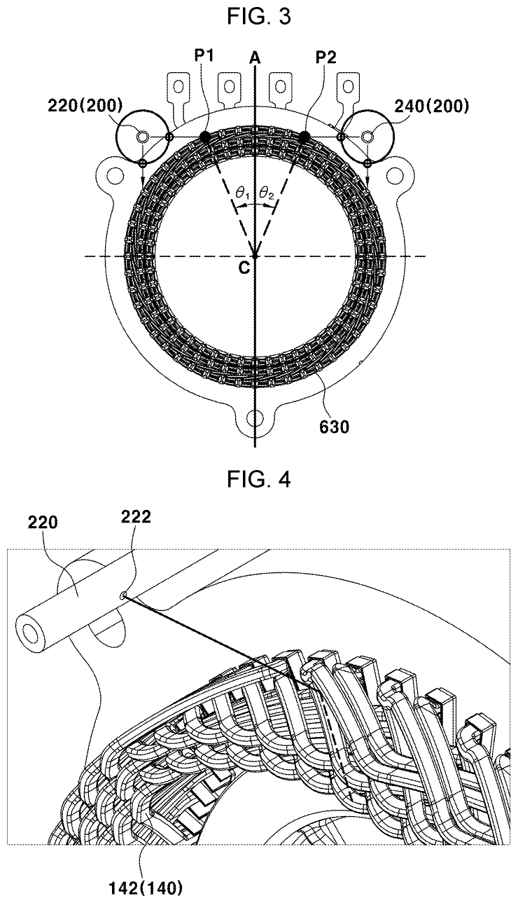

Referring to FIG. 3, an angle between a vertical axis A and a line connecting P1 and C may be referred to as a first angle θ₁ where P1 is a point where a straight line configured to connect the center portion of the first cooling pipe 220 to the first front injection hole 222 comes into contact with the front-side coils 142 and C denotes a center portion point of the motor 630. An angle between the vertical axis A and a line connecting P2 and C may be referred to as a second angle θ₂ where P2 is a point where a straight line configured to connect the center portion of the second cooling pipe 240 to the second front injection hole 242 comes into contact with the front-side coils 142. Only when the first angle θ₁ and the second angle θ₂ satisfy a predetermined angle value, the sizes of the first front injection hole 222 and the second front injection hole 242 are corrected according to the coefficient of size change k. For example, each of the first angle θ₁ and the second angle θ₂ may be the predetermined angle value, i.e., 18°, and in the instant case, the coefficient of size change k may be 1.2.

According to some modified examples of the present invention, the above-described effects may be acquired by increasing or decreasing the number of injection holes without changing the sizes of the injection holes.

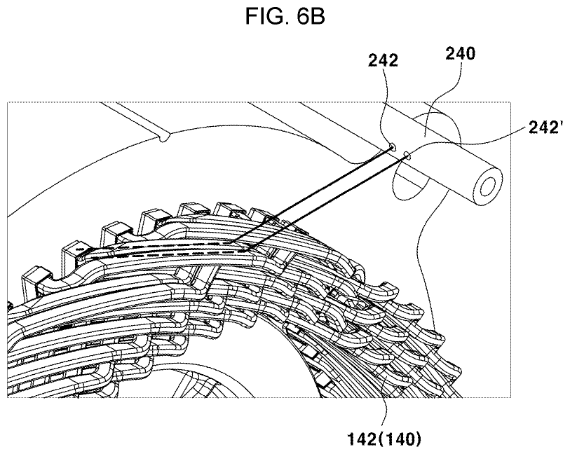

Referring to FIG. 6A and FIG. 6B, together with the second front injection hole 242 configured to enable the majority of the amount of oil to permeate into the front-side coils 142, a third front injection hole 242′ may be formed through the second cooling pipe 240 by punching. Those skilled in the art will appreciate that such a structure is applicable to the rear portion of the motor 630, and a detailed description of application of the present structure to the rear portion of the motor 630 will thus be omitted.

The structure for injecting cooling oil according to various exemplary embodiments of the present invention may improve the cooling performance of the motor 630 under the same flow rate (LPM). By decreasing the amount of oil that bounces off from the coils 140 and is lost and increasing the amount of oil which is actually used for cooling, under the same amount of oil, a cooling effect that would normally be achieved at a higher LPM may be achieved at the same LPM. For example, when the diameter of the first front injection hole 222 is decreased to 70% compared to the existing diameter thereof and the diameter of the second front injection hole 242 is increased as much as the decrease, the amount of oil which is lost is reduced by 50% or more, and such an amount of oil may be used for cooling. The increased effective amount of oil used for cooling flows down along the wall of the stator core 120 and permeates into the coils 140, which emit a large amount of heat, effectively assisting cooling of the internal regions of the coils 140. Consequently, the ability to prevent dielectric breakdown of the motor stator and demagnetization of the permanent magnets of the rotor due to the increased cooling performance may also be secured. Therefore, replacement costs of the motor due to demagnetization thereof may be reduced.

The structure for injecting cooling oil according to various exemplary embodiments of the present invention improves the driving performance of a vehicle. When the temperature sensors detect overheating of the motor 630 due to the increase in the temperature of the coils 140 and thus logic for protecting the motor 630 from overheating is executed, the driving power performance of the motor 630 is reduced due to derating. However, in the structure for injecting cooling oil according to various exemplary embodiments of the present invention, the amount of oil injected into the stator is the same and an additional amount of oil permeates into the coils at the same flow rate (LPM). Thus, cooling performance with respect to the inside of the stator 100 and the rotor is improved. The structure for injecting cooling oil according to various exemplary embodiments of the present invention increases freedom from derating and may enable the vehicle to exhibit more stable driving performance.

The structure for injecting cooling oil according to various exemplary embodiments of the present invention may increase the range of the vehicle. An improvement in cooling performance indicates that cooling oil absorbs a larger amount of heat from the motor, which is the target to be cooled. That is to say, the structure for injecting cooling oil according to various exemplary embodiments of the present invention may lower the temperature of the motor and raise the temperature of cooling oil, compared to the conventional structure. Consequently, current and copper losses are reduced due to the decrease in the temperature of the motor, and the range of the vehicle is increased. Furthermore, the viscosity of the cooling oil is reduced due to the increase in the temperature of the cooling oil, and thus, the loss caused by drag applied to the reducer is reduced. Therefore, the efficiencies of both the motor and the reducer are increased, and thus, the range of the vehicle may be increased.

As is apparent from the above description, various aspects of the present invention are directed to providing a structure for injecting cooling oil which has excellent cooling performance and excellent cooling efficiency.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The foregoing descriptions of specific exemplary embodiments of the present invention have been presented for purposes of illustration and description. They are not intended to be exhaustive or to limit the present invention to the precise forms disclosed, and obviously many modifications and variations are possible in light of the above teachings. The exemplary embodiments were chosen and described to explain certain principles of the present invention and their practical application, to enable others skilled in the art to make and utilize various exemplary embodiments of the present invention, as well as various alternatives and modifications thereof. It is intended that the scope of the present invention be defined by the Claims appended hereto and their equivalents.

What is claimed is:

1. A structure for injecting cooling oil, the structure comprising:
a motor including a stator core and coils wound on the stator core, wherein the coils protrude from the stator core and extend obliquely in an axial direction of the stator core;
a first cooling pipe mounted at a first side of the motor at a distance apart from the coils and including a first injection hole to inject oil onto the coils therethrough; and
a second cooling pipe mounted at a second side of the motor at a space apart from the coils and including a second injection hole to inject oil onto the coils therethrough,
wherein the first injection hole is configured to inject oil onto portions of the coils extending obliquely outwards from the stator core in a direction moving away from the first injection hole,
wherein the second injection hole is configured to inject oil onto portions of the coils extending obliquely toward the stator core in a direction moving away from the second injection hole, and
wherein the second injection hole has a diameter greater than a diameter of the first injection hole.

2. The structure of claim 1, wherein the oil injected through the first cooling pipe and the second cooling pipe to which an electric oil pump is fluidically connected is supplied from the electric oil pump of a vehicle.

3. The structure of claim 1, wherein the motor is a hairpin winding motor.

4. The structure of claim 1, wherein the first cooling pipe and the second cooling pipe are disposed to be symmetrical with each other about the motor.

5. The structure of claim 1, wherein the first injection hole and the second injection hole are disposed in the first cooling pipe and the second cooling pipe, respectively, to be symmetrical with each other about the motor.

6. The structure of claim 1,
wherein a first angle is formed by a line connecting a position, at which an imaginary straight line connecting a center portion of the first cooling pipe to the first injection hole extends to the coils, to a center portion of the motor and a vertical axis passing through the center portion of the motor,
wherein a second angle is formed by a line connecting a position, at which an imaginary straight line connecting a center portion of the second cooling pipe to the second injection hole extends to the coils, to the center portion of the motor and the vertical axis passing through the center portion of the motor, and
wherein even when the first cooling pipe and the second cooling pipe are not symmetrical with each other about the motor, the diameter of the second injection hole is greater than the diameter of the first injection hole if each of the first angle and the second angle is within a predetermined angle value.

7. The structure of claim 1,
wherein the second cooling pipe includes a plurality of second injection holes, and
wherein a sum total of diameters of the second injection holes is greater than the diameter of the first injection hole.

8. The structure of claim 1,
wherein the first injection hole is in plural to include a first front injection hole provided at a front portion of the motor and a first rear injection hole provided at a rear portion of the motor.

9. The structure of claim 1,
wherein the second injection hole is in plural to include a second front injection hole provided at a front portion of the motor and a second rear injection hole provided at a rear portion of the motor.

10. A structure for injecting cooling oil, the structure comprising:
a motor including a stator core and coils wound on the stator core;
a first cooling pipe mounted at a first side of the motor to be spaced from the coils with a predetermined distance and including a first front injection hole injecting oil onto first front portions of the coils and a first rear injection hole injecting oil onto first rear portions of the coils; and
a second cooling pipe mounted at a second side of the motor to be spaced from the coils with a predetermined distance and including a second front injection hole injecting oil onto second front portions of the coils and a second rear injection hole injecting oil onto second rear portions of the coils,
wherein the first front portions are a portion of each of the coils protruding obliquely outwards from the stator core and then extending in a direction moving away from the first cooling pipe, and the second front portions are a portion of each of the coils protruding obliquely outwards from the stator core and then extending in a direction approaching the second cooling pipe,
wherein the first rear portions are a portion of each of the coils protruding obliquely outwards from the stator core and then extending in a direction approaching the first cooling pipe, and the second rear portions are a portion of each of the coils protruding obliquely outwards from the stator core and then extending in a direction moving away from the second cooling pipe,
wherein the second front injection hole has a diameter greater than a diameter of the first front injection hole, and
wherein the second rear injection hole has a diameter smaller than a diameter of the first rear injection hole.

11. The structure of claim 10, wherein a sum total of the diameters of the first front injection hole and the first rear injection hole is a same as a sum total of the diameters of the second front injection hole and the second rear injection hole.

12. The structure of claim 1, wherein the coils protrude from the stator core obliquely with respect to the axial direction of the stator core, are bent at least once in a radial direction and a circumferential direction of the stator core and in at least one of the radial direction and the circumferential direction thereof, respectively, and then enter the stator core obliquely with respect to the axial direction of the stator core.

13. The structure of claim 10,
wherein a first angle is formed by a line connecting a position, at which an imaginary straight line connecting a center portion of the first cooling pipe to the first front injection hole extends to the coils, to a center portion of the motor and a vertical axis passing through the center portion of the motor,
wherein a second angle is formed by a line connecting a position, at which an imaginary straight line connecting a center portion of the second cooling pipe to the second front injection hole extends to the coils, to the center portion of the motor and the vertical axis passing through the center portion of the motor, and
wherein the first angle and the second angle are within a predetermined angle value.
